(19) United States
(12) Patent Application Publication
(10) Pub. No.: US 2026/0218611 A1
(43) Pub. Date: Jul. 30, 2026

(54) MODULAR CARBIDE TOOLING, HARD AND EXOTIC MATERIALS COMBINED WITH HOLDERS OF DIFFERENT MATERIALS WITH OPTIONS FOR WEAR AND PROTECTION AND MACHINE TIE

(71) Applicant: Kennametal Inc., Latrobe, PA (US)

(72) Inventor: Grzegorz Dewicki, Greensburg, PA (US)

(21) Appl. No.: 19/040,452

(22) Filed: Jan. 29, 2025

(51) Int. Cl. E21C 35/183; B28D 1/18

(52) U.S. Cl. CPC E21C 35/1831; B28D 1/188

(57) ABSTRACT

A modular cutting tool comprising a cutting tool body, a retainer ring and cutting tip. The cutting tool body has an axial forward end and an axial rearward end. The forward end is of a frusto-conical shape having a socket with internal threads. The retainer ring has an internal hole including tapered internal sidewalls. The retainer ring includes external threads. A cutting tip is affixed in the internal hole of the retainer ring. The external threads of the retainer ring engage the internal threads of the tool body to secure the retainer ring to the cutting tool body.

### FIELD OF THE INVENTION

The present invention relates to a modular cutting tool. More particularly, the present invention relates to a modular rotatable cutting tool for mining and road milling applications.

### BACKGROUND INFORMATION

The present invention pertains to a rotatable cutting tool that is useful for the impingement of earth strata such as, for example, asphaltic roadway material, coal deposits, mineral formations and the like. More specifically, the present invention pertains to a rotatable cutting tool that is useful for the impingement of earth strata, and especially a rotatable cutting tool body that is of a modular design that accepts a variety of cutting tips depending upon the intended application.

Heretofore, rotatable cutting tools have been used to impinge earth strata such as, for example, asphaltic roadway material. U.S. Patent No. 4,201,421 to Den Besten et al,. and U.S. Patent No. 4,497,520 B2 to Ojanen are exemplary of rotatable cutting tools used to impinge earth strata, and especially asphaltic roadway material.

Generally speaking, rotatable cutting tools useful to impinge earth strata have an elongate rotatable cutting tool body typically made from steel and a hard tip (or insert) affixed to the rotatable cutting tool body at the axial forward end thereof by brazing. The hard tip is typically made from a hard material such as, for example, cemented (cobalt) tungsten carbide. The rotatable cutting tool is retained or held in the bore of a tool holder such as shown in U.S. Patent No. 6,478,383 to Ojanen et al. In the alternative, the rotatable cutting tool is retained in the bore of a sleeve that is, in turn, held in the bore of a holder such as shown in U.S. Patent No. 6,786,557 to Montgomery, Jr.

The holder is affixed to a driven member such as, for example, a driven drum of a road milling machine, roadheaders or continuous miners. In some designs, the driven member (e.g., road milling drum) carries hundreds of holders wherein each holder carries a rotatable cutting tool. Hence, the driven member may carry hundreds of rotatable cutting tools. The driven member is driven (e.g., rotated) in such a fashion so that the hard tip of each one of the rotatable cutting tools impinges or impacts the earth strata (e.g., asphaltic roadway material) thereby fracturing and breaking up the material into debris. U.S. Patent No. 5,536,073 to Sulosky et al. is exemplary of a road milling drum.

As can be appreciated, rotatable cutting tools that impinge earth strata such as asphaltic roadway material operate in a severe environment. The severe operational environment subjects the components of the rotatable cutting tool to both severe abrasive wear and severe stress. When the cutting tip is worn or requires replacement the entire rotatable cutting tool is typically replaced. This requires that the machine is removed from production while the rotatable cutting tool is repaired or replaced. In order to improve and simplify the repair or replacement of the rotatable cutting tool it would be desirable to provide a modular rotatable cutting tool wherein a cutting tip can be easily repaired or replaced without replacement of the entire rotatable cutting tool leading to inefficiencies and extended machine downtime.

These and other aspects of the present invention will be more apparent from the following description.

### SUMMARY OF THE INVENTION

The present invention aims at managing the above-mentioned problems and at improving the design of cutting tools by providing a cutting tool that when worn or requiring replacement either the cutting tip or cutting body may be easily replaced. serrations and a two part clamping jaw having a flexible upper jaw for holding a cutting insert

The modular cutting tool includes a cutting tool body, a retainer ring and cutting tip.

The cutting tool body has an axial forward end and an axial rearward end. The forward end is of a frusto-conical shape having a socket with internal threads. The retainer ring has an internal hole including tapered internal sidewalls. The retainer ring includes external threads. A cutting tip is affixed in the internal hole of the retainer ring. The external threads of the retainer ring engage the internal threads of the tool body to secure the retainer ring to the cutting tool body

The retainer ring includes a cylindrical body and a frusto-conical shape tip. The cylindrical body fits within the socket of the cutting tool body.

The cutting tip is a hard insert. The hard insert is fixed within the hole of the retainer ring.

When the cutting tip or the cutting tool body are replaced, the retainer ring is threadingly disconnected from the cutting tool body and either the cutting tip or the cutting tool body are replaced without having to replace both the cutting tip and cutting tool body.

These and other aspects of the present invention will be more apparent from the following description.

### BRIEF DESCRIPTION OF THE DRAWINGS

In order that the present invention may be more clearly ascertained, some embodiments will now be described, by way of example, with reference to the accompanying drawings, in which:

FIG. 1 is a perspective view of a modular rotatable cutting tool;

FIG. 2 is an exploded view of the modular rotatable cutting tool of FIG. 1;

FIG. 3 is a cross sectional view of the modular rotatable cutting tool of FIG. 1;

FIG. 4 is a top view of the modular rotatable cutting tool of FIG. 1; and

FIG. 5 is a side view of the modular rotatable cutting tool of FIG. 1.

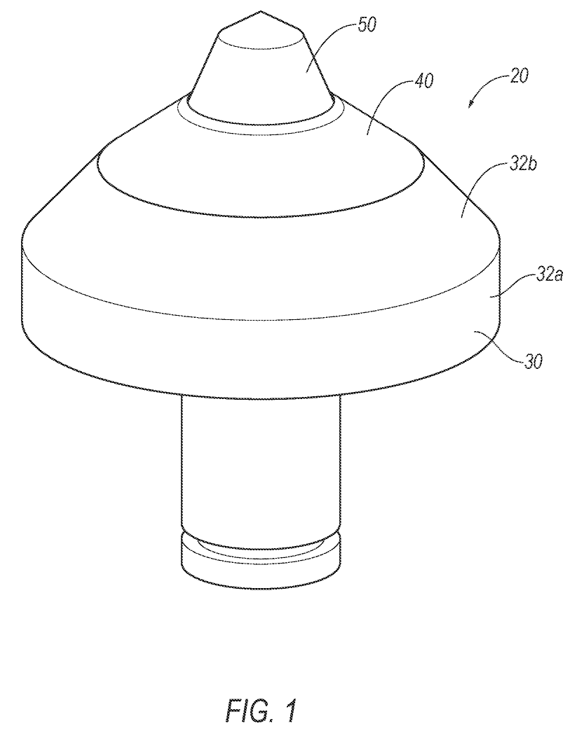

### DETAILED DESCRIPTION

The present disclosure now will be described more fully hereinafter with reference to the accompanying drawings, in which various exemplary implementations are shown. The invention may, however, be embodied in many different forms and should not be construed as limited to the exemplary implementations set forth herein. These example exemplary implementations are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

The terminology used herein is for the purpose of describing particular exemplary implementations only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”.

Terms such as “about” or “approximately” or “on the order of” may reflect amounts, sizes, orientations, or layouts that vary only in a small relative manner, and/or in a way that does not significantly alter the operation, functionality, or structure of certain elements.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element, there are no intervening elements present. Other words used to describe the relationship between elements should be interpreted in a like fashion (e.g., “between” versus “directly between,” “adjacent” versus “directly adjacent,” etc.).

Referring to the drawings, the figures illustrate one specific embodiment of a modular rotatable cutting tool generally designated as 20. Although the invention will be described with reference to a rotatable cutting tool it will be appreciated that the invention is equally applicable to nonrotating cutting tools.

The modular rotatable cutting tool 20 as shown in the figures comprises an elongate rotatable cutting tool body generally designated as 30, a retainer ring 40 and a cutting tip 50. The rotatable cutting tool body 30 is typically made from steel such as those grades disclosed in U.S. Patent No. 4,886,710 to Greenfield. Grade 15B37H Modified is the preferred grade of steel for the rotatable cutting tool body 30. Grade 15B37H Modified has the following nominal composition (in weight percent): 0.33-0.38 % carbon, 1.10-1.35 % manganese, 0.0005% minimum boron, 0.15-0.30% silicon, 0.045 % maximum sulfur, 0.035 % maximum phosphorus and the balance iron. Grade 15B37H Modified has a minimum hardenability equal to about 52 HRc.

The rotatable cutting tool body 30 has an axial forward end 32 and an axial rearward end 34. The forward end 32 is generally of cylindrical body 32a including a frustro-conical shape tip 32b. A socket 36 is formed in the frusto-conical shape tip. The socket 36 includes internal threads 38.

The retainer ring 40 is generally a cylindrical body 40a having a frusto-conical shape tip 40b. In one embodiment, the cylindrical body 40a has a diameter to fit within the socket 36. However, it will be appreciated that the body 40a may be a shape other than cylindrical and shaped to fit within the socket 36. The outer surface 42 of the frustrum of the retainer ring 40 blends with the outer surface 33 of the frustrum of the cutting tool body 30. The retainer ring 40 includes an internal hole 44. The internal hole 44 is formed as a tapered internal hole that narrows upwardly (decreases in diameter) from the bottom of the hole 44 to the top of the hole. In one embodiment, the outer surface of the cylindrical body 40a of the retainer ring 40 includes external threads 46. The external threads 46 correspond with the internal threads 38 of the socket such that the external threads of the retainer ring threadingly engage the internal threads of the socket of the rotatable cutting tool body to secure the retainer ring with respect to the cutting tool body 30. However, it will be appreciated that the ring 40 may be secured to the cutting tool body 30 by a spring clip or shrink fit interference fit.

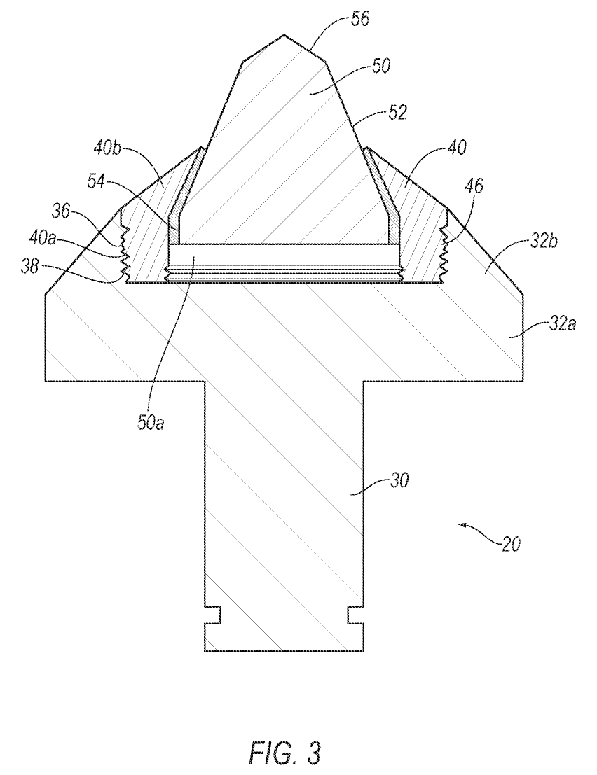

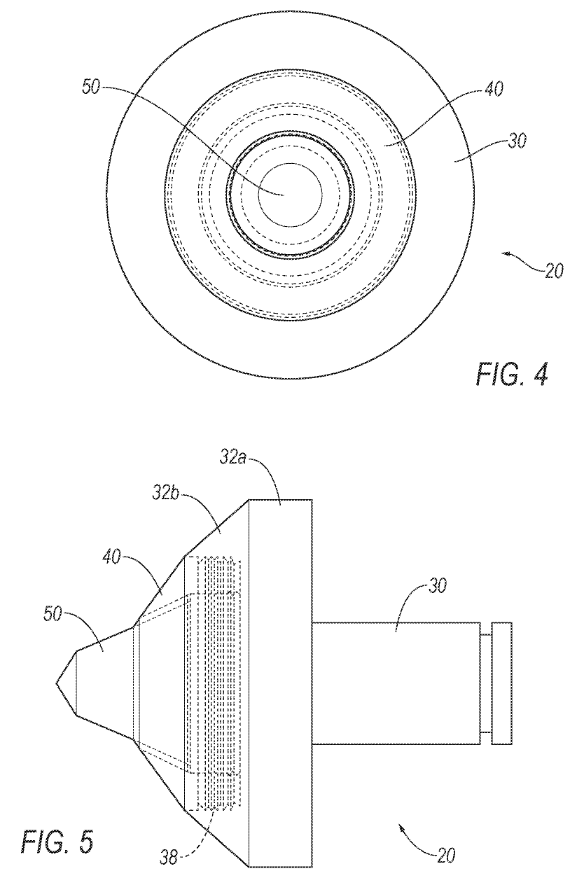

A cutting tip 50 such as a hard insert is affixed (such as by brazing or the like) in the hole 44 of the retainer ring 40 in the axial forward end 32 of the rotatable cutting tool body 30. The cutting tip 50 has tapered side surfaces 52 extending from a base 54 to the tip 56 . As shown in FIG. 3., an additional spacer 50a may be included between the cutting tip 50 and cutting tool body 30. The spacer 50a may be of a hardness adapted to suit the intended application. For example, the spacer 50a may be of a material softer or harder than the cutting tip material 50 as desired. The hard insert may be made from cemented carbide such as, for example, cobalt cemented tungsten carbide wherein U.S. Patent No. 6,375,272 to Ojanen discloses acceptable grades of cemented (cobalt) tungsten carbide or alternatively the hard insert may be a made of a superhard material such as polycrystalline diamond, vapor-deposited diamond, natural diamond, cubic boron nitride, infiltrated diamond, layered diamond, diamond impregnated carbide, diamond impregnated matrix, silicon bounded diamond, or combinations thereof. Also, the superhard material may be sintered with a catalytic element comprising iron, cobalt, nickel, silicon, hydroxide, hydride, hydrate, phosphorus-oxide, phosphoric acid, carbonate, lanthanide, actinide, phosphate hydrate, hydrogen phosphate, phosphorus carbonate, alkali metals, alkali earth metals, ruthenium, rhodium, palladium, chromium, manganese, tantalum or combinations thereof.

The geometry of the cutting tip 50 can vary depending upon the specific application. U.S. Patent No. 4,497,520 B2 to Ojanen and U.S. Patent No. 6,375,272 to Ojanen each disclose an exemplary geometry for the cutting tip.

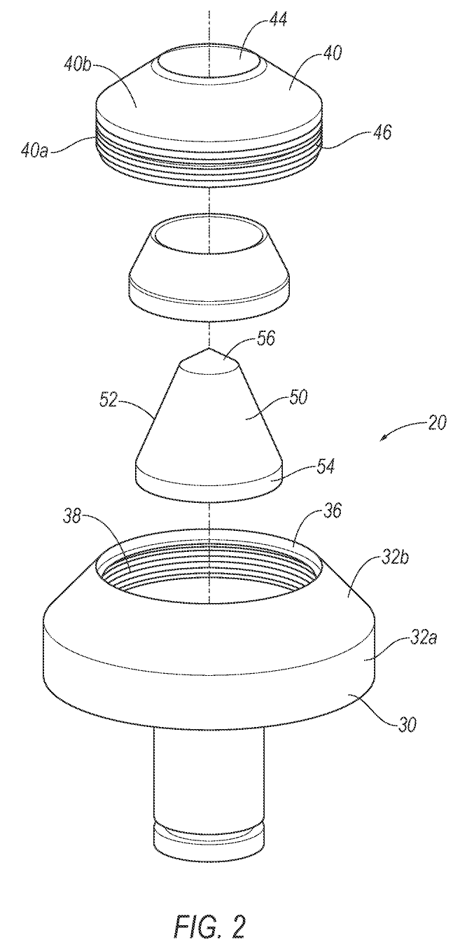

The cutting tip 50 is inserted into the hole 44 of the retainer ring 40 from the bottom of the ring and projects beyond the frustrum. As shown in FIGS. 2 and 3, the cutting tip 50 is secured within the retainer ring 40 by a mechanical interference fit of the tapered sidewalls 52 and brazing to the retainer ring. U.S. Patent No. 5,141,289 discloses braze alloys that typically are used to braze the cutting tip 50 to the retainer ring 40 in the rotatable cutting tool body 30.

When either the cutting tip 50 or the cutting tool body 30 is worn or requires replacement, the retainer ring 40 is threadingly disconnected from the cutting tool body 30 and replaced with a new cutting tip or tool body as appropriate and then threadingly reconnected to provide a modular cutting tool that may be used without completely replacing the entire cutting tool.

The patents and patent applications referenced herein are hereby incorporated by reference.

Whereas particular embodiments of this invention have been described above for purposes of illustration, it will be evident to those skilled in the art that numerous variations of the details of the present invention may be made without departing from the invention as defined in the appended claims.

1. A modular cutting tool comprising:
a cutting tool body, the cutting tool body having an axial forward end and an axial rearward end, wherein the forward end is of a frusto-conical shape having a socket with internal threads;
a retainer ring, the retainer ring having an internal hole including tapered internal sidewalls, the retainer ring having external threads; and
a cutting tip affixed in the internal hole of the retainer ring,
wherein the external threads of the retainer ring engage the internal threads of the tool body to secure the retainer ring to the cutting tool body.

2. The modular cutting tool of claim 1 wherein the retainer ring includes a cylindrical body having a frusto-conical shape tip.

3. The modular cutting tool of claim 2 wherein the cylindrical body has a diameter to fit within the socket.

4. The modular cutting tool of claim 1 wherein the cutting tip is a hard insert.

5. The modular cutting tool of claim 4 wherein the hard insert is brazed in the hole of the retainer ring.

6. The modular cutting tool of claim 4 wherein the cutting tip has tapered side surfaces.

7. The modular cutting tool of claim 6 wherein the cutting tip is a cemented tungsten carbide insert.

8. The modular cutting tool of claim 1 wherein the cutting tool is a rotatable cutting tool.

9. The modular cutting tool of claim 1 further comprising a spacer between the cutting tip and the cutting tool body.

10. A modular cutting tool comprising:
a cutting tool body, the cutting tool body having an axial forward end and an axial rearward end, wherein the forward end is of a frusto-conical shape having a socket with internal threads;
a retainer ring, the retainer ring having an internal hole and a cylindrical body having external threads, the cylindrical body having a diameter to fit within the socket; and
a cutting tip affixed in the internal hole of the retainer ring,
wherein the external threads of the retainer ring engage the internal threads of the tool body to secure the retainer ring to the cutting tool body.

11. The modular cutting tool of claim 10 wherein the cutting tool is a rotatable cutting tool.

12. The modular cutting tool of claim 11 wherein the cylindrical body has a diameter to fit within the socket.

13. The modular cutting tool of claim 12 wherein the cutting tip is a hard insert.

14. The modular cutting tool of claim 13 wherein the hard insert is brazed in the hole of the retainer ring.

15. The modular cutting tool of claim 14 wherein the cutting tip is a cemented tungsten carbide insert.

16. The modular cutting tool of claim 10 wherein the cutting tool is a rotatable cutting tool.

17. The modular cutting tool of claim 10 further comprising a spacer between the cutting tip and the cutting tool body.
